(19) United States
(12) Patent Application Publication
(10) Pub. No.: US 2009/0146923 A1
(43) Pub. Date: Jun. 11, 2009

(54) PLASMA DISPLAY DEVICE AND PLASMA DISPLAY PANEL

(75) Inventors: Makoto Takaura, Miyazaki (JP); Yasuhiko Kunii, Miyazaki (JP); Masashi Ohta, Miyazaki (JP); Hideyuki Shintani, Mobara (JP)

Correspondence Address: MILES & STOCKBRIDGE PC, 1751 PINNACLE DRIVE, SUITE 500, MCLEAN, VA, 22102-3833, US

(73) Assignee: HITACHI, LTD.

(21) Appl. No.: 12/187,479

(22) Filed: Aug. 7, 2008

(30) Foreign Application Priority Data
Dec. 11, 2007 (JP) 2007-319284

(51) Int. Cl. G09G 3/28

(52) U.S. Cl. 345/60

(57) ABSTRACT

A PDP comprises an X electrode and a Y electrode forming a display electrode pair, and an address electrode. Upon a reset discharge for forming charges to all of a plurality of cells, the X electrode becomes a cathode and the Y electrode becomes an anode. On the other hand, upon a sustain discharge for forming a display image, the X electrode and the Y electrode alternately becomes the cathode or the anode so as to repeatedly perform discharges. Here, a distribution of visible light transmissivity inside a cell of a front surface substrate structure has a first region and a second region having a higher visible light transmissivity than the first region, and the first region includes a region superposed with an X transparent electrode in the thickness direction, and the second region includes a region superposed with a Y transparent electrode in the thickness direction.

### CROSS-REFERENCE TO RELATED APPLICATION

The present application claims priority from Japanese Patent Application No. JP 2007-319284 filed on Dec. 11, 2007, the content of which is hereby incorporated by reference into this application.

### BACKGROUND OF THE INVENTION

The present invention relates to a technology of a plasma display device, and in particular, it relates to a technique effectively applied to an AC type plasma display device.

As an electrode structure of a plasma display panel (PDP) embedded in an AC type color plasma display device (hereinafter, referred to as PDP device), for example, there is a two-electrode PDP, in which a first electrode extending in a column direction is provided in parallel to each other, and a plurality of second electrodes extending in a row direction orthogonal to the column direction are provided mutually in parallel.

As another electrode structure, for example, there is also a three-electrode PDP, in which a plurality of first electrodes and second electrodes extending in the column direction are alternately provided in parallel, and a plurality of address electrodes extending in the row direction orthogonal to the column direction are mutually provided in parallel, and in recent years, this three-electrode PDP are widely used.

A general structure of this three-electrode PDP is such that a first substrate which is a substrate of the display surface side is alternately provided with a sustain (X) electrode and a scan electrode (Y) configuring a display electrode pair along the column direction, respectively. A second substrate opposing to the first substrate is provided with an address electrode along the row direction orthogonal to the column direction, and the surface of each electrode is covered by a dielectric layer, respectively.

On the second substrate, for example, a barrier rib (stripe rib) disposed in a stripe pattern along the column direction between adjacent address electrodes is also formed, and a phosphor layer is formed in a space partitioned by the barrier ribs.

As a display method of such a PDP, an address/display separated method (ADS: Address Display Period Separated Subfield Method) that separates a period (address period) regulating cells to be displayed and a display period (sustain discharge period) performing a discharge for turning on display is widely adopted. In this method, in an address period, charges are accumulated in the cell to be on, and the charges are used so that a discharge (referred to as sustain discharge or display discharge) for display in the sustain discharge period is performed.

First, a voltage is applied across the sustain electrode and the scan electrode, thereby generating a reset discharge in every cell, so that charges (wall charges) in the vicinity of each electrode are put into a uniform state. Next, an address operation is performed, in which a scan pulse is applied in sequence to the scan electrode and an address pulse is applied to the address electrode synchronized with the scan pulse, thereby selectively leaving the wall charges inside the cell to be on. After that, sustain discharge pulses having opposite polarities are applied alternately across the discharging sustain and scan electrodes, so that the sustain discharge is generated so that the on cell where the wall charges are formed is turned on by the address discharge. The phosphor layer emits light by ultraviolet ray generated by the discharge and its visible light transmits the first substrate, so that a desired image is formed.

Thus, the sustain electrode and the scan electrode are configured by a transparent electrode formed of a transparent material such as an ITO film and an opaque bus electrode formed of a metal material. It is structured such that the visible light generated by the phosphor layer transmits through the transparent electrode to reach the display surface side.

Here, the light emission by discharge is generated also at the time of performing the reset discharge between the sustain electrode and the scan electrode. The reset discharge is performed to adjust the wall charges of every cell as described above, and it is a discharge which does not directly relates to the image display. Therefore, the emission by the reset discharge becomes a background emission, and it causes a problem that the display contrast (particularly, dark-room contrast) is lowered.

As a technology for suppressing such the contrast lowering caused by the emission by the reset discharge, for example, Japanese Patent No. 3872551 (Patent Document 1) discloses a structure in which an optical filter is formed in a region close to a discharge gap between a sustain electrode and a scan electrode and the background emission upon reset discharge is absorbed by this optical filter.

### SUMMARY OF THE INVENTION

Meanwhile, as described in the Patent Document 1, when the optical filter for absorbing visible light is formed in the region close to the discharge gap, the following problems arise.

That is, at the time of performing the sustain discharge which is a discharge for forming a desired image, the emission (referred to as sustain emission) from the phosphor layer excited by the ultraviolet ray generated by the sustain discharge is absorbed by the optical filter.

Further, in the sustain emission, the emission of the region of the discharge gap periphery is the highest in luminance. Thus, when the optical filter is formed in the region close to the discharge gap, not only the visible light by the reset discharge is reduced, but also the visible light for displaying the pixel is absorbed, so that the brightness itself of the PDP is lowered.

The present invention has been made in view of the above-described problems, and an object of the present invention is to provide a technology capable of suppressing brightness lowering of a PDP and also improving the contrast.

The above and other objects and novel characteristics of the present invention will be apparent from the description of this specification and the accompanying drawings.

To solve the above-described problems, as a result of the study and the experiment conducted by the inventors of the present invention, it was experimentally found that the distribution inside the cell of the visible light generated at the reset discharge time clearly shows that a relative emission intensity of the visible light of a first region superposed (overlapped) with an electrode which serves as a cathode at the time of reset discharge in the thickness direction is larger than a relative emission intensity of the visible light of a second region superposed with an electrode which serves as an anode at the time of reset discharge in the thickness direction.

On the one hand, at the time of performing the sustain discharge which is a discharge for forming a desired image, it was found that the sustain electrode and the scan electrode configuring a display electrode pair alternately becomes a cathode or an anode so as to repeatedly perform discharges, whereby the distribution of visible light generated by the sustain discharge inside the cell can be prevented from being deflected to either one side of the electrodes.

The typical ones of the inventions disclosed in this application will be briefly described as follows.

Specifically, a plasma display device according to an embodiment of the present invention comprises: a plasma display panel; a first electrode driving circuit that drives a first electrode formed to the plasma display panel; and a second electrode driving circuit that drives a second electrode formed to the plasma display panel.

In addition, the plasma display panel comprises: a first substrate structure and a second substrate structure which are arranged opposing to each other interposing a discharge gap; a the first electrode and the second electrode formed along a first direction so as to configure a display electrode pair to the first substrate structure arranged at a display surface side of the plasma display panel; a dielectric layer that covers the first electrode and the second electrode; a third electrode formed along a second direction intersecting the first direction to the first substrate structure or the second substrate structure; and a plurality of cells formed at every intersection of the display electrode and the third electrode.

Here, at the time of a reset discharge for forming charges to all of the plurality of cells, the first electrode works as a cathode and the second electrode works as an anode, and on the contrary, at the time of a sustain discharge for forming a display image, the first electrode and the second electrode alternately work as a cathode or an anode, thereby performing discharges repeatedly.

Moreover, the first electrode and the second electrode respectively have a transparent electrode portion and a metal electrode portion electrically connected to the transparent electrode portion, and a transmissivity distribution of visible light in the cell of the first substrate structure has a first region having a first transmissivity of visible light and a second region having a second transmissivity of visible light, where the first region includes a region superposed with the transparent electrode portion comprised in each of the plurality of first electrodes in a thickness direction and the second region includes a region superposed with the transparent electrode portion comprised in each of the plurality of second electrodes in the thickness direction.

The effects obtained by typical aspects of the present invention will be briefly described below.

Specifically, according to the present invention, as well as suppressing luminance lowering of a PDP, it is possible to improve contrast.

### BRIEF DESCRIPTIONS OF THE DRAWINGS

These and other features, objects and advantages of the present invention will become apparent from the following description when taken in conjunction with accompanying drawings wherein:

FIG. 1 is a block diagram schematically showing an overall structure of one example of a PDP device embedding a PDP according to a first embodiment of the present invention;

FIG. 2 is an explanatory diagram showing one example of a grayscale drive sequence in the PDP device shown in FIG. 1;

FIG. 3 is an explanatory diagram showing one example of a drive waveform of the PDP device shown in FIG. 1;

FIG. 4 is an enlarged perspective view of main parts of the PDP according to the first embodiment of the present invention;

FIG. 5 is an enlarged plan view of main parts seen from a display surface side showing a two-dimensional positional relationship among a electrode group, a barrier rib, and a light absorbing layer shown in FIG. 4;

FIG. 6 is an explanatory diagram showing a distribution (at the time of reset discharge and sustain discharge) of emission intensity inside one cell in a state where the light absorbing layer of the PDP shown in FIG. 5 is not formed;

FIG. 7 is an explanatory diagram showing a potential distribution inside one cell in a state where the light absorbing layer of the PDP shown in FIG. 5 is not formed and a distribution of existence probability of positive ions and electrons;

FIG. 8 is an enlarged cross-sectional view of main parts showing a cross section taken along the line B-B shown in FIG. 5;

FIG. 9 is an enlarged plan view of main parts seen from the display surface side showing a two-dimensional positional relationship among the electrode group, the barrier rib, and the light absorbing layer which the PDP comprises according to a first modification example of the first embodiment of the present invention;

FIG. 10 is an enlarged cross-sectional view of main parts showing a cross section taken along the line C-C shown in FIG. 9;

FIG. 11 is an enlarged plan view of main parts seen from the display surface side showing a two-dimensional positional relationship among the electrode group, the barrier rib, and the light absorbing layer which the PDP comprises according to a second modification example of the first embodiment of the present invention;

FIG. 12 is an enlarged plan view of main parts showing one piece of a cell 25 of the PDP shown in FIG. 11;

FIG. 13 is an enlarged plan view of main parts seen from the display surface side showing a two-dimensional positional relationship among the electrode group, the barrier rib, and the light absorbing layer which a PDP comprises according to a second embodiment of the present invention;

FIG. 14 is an enlarged plan view of a main part showing one piece of the cell 25 of the PDP shown in FIG. 13;

FIG. 15 is an enlarged cross-sectional view of main parts showing a part of a cross section in a row direction of a PDP according to a third embodiment of the present invention; and

FIG. 16 is an enlarged cross-sectional view of main parts showing a part of the cross section in a row direction of the PDP according to a modification example of the third embodiment of the present invention.

### DESCRIPTIONS OF THE EMBODIMENTS

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof.

In addition, components having the same function are denoted by the same reference symbols throughout the drawings for describing the embodiments, and the repetitive description thereof is omitted. Also, in some drawings used in the embodiments, hatching is used even in a plan view so as to make the drawings easy to see.

### First Embodiment

<Overall Configuration of Plasma Display Device>

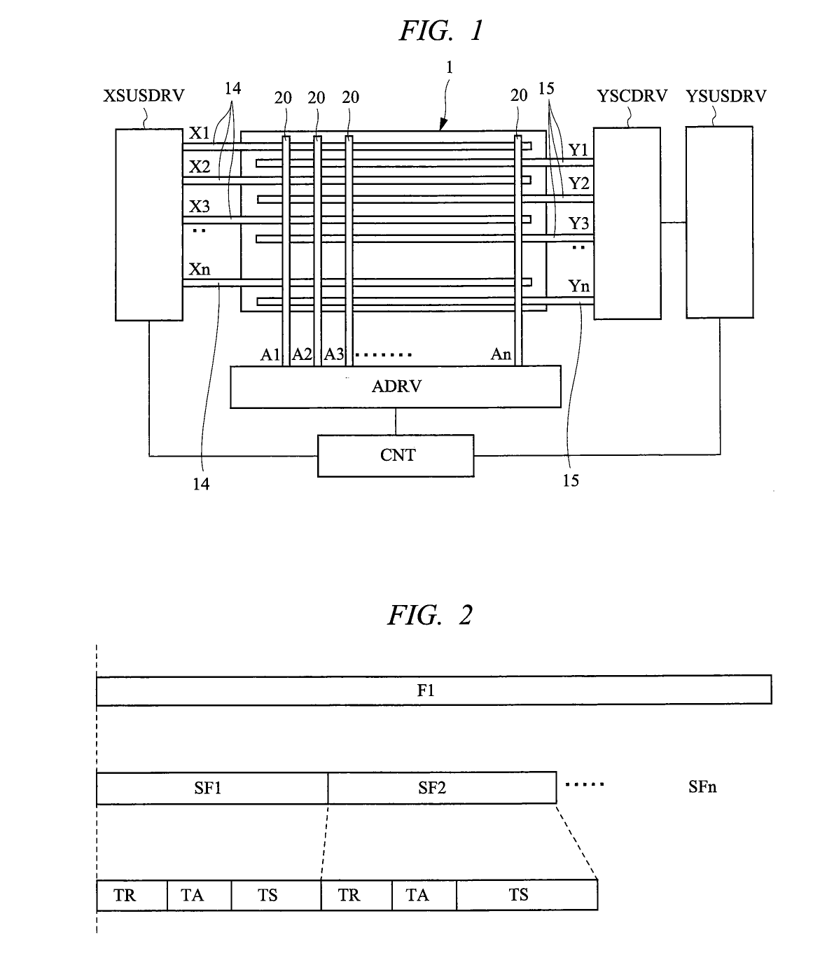

First, an overall configuration of a plasma display device (hereinafter, referred to as PDP device) embedding a PDP 1 of a first embodiment and a method of grayscale drive thereof will be described with reference to FIGS. 1 to 3.

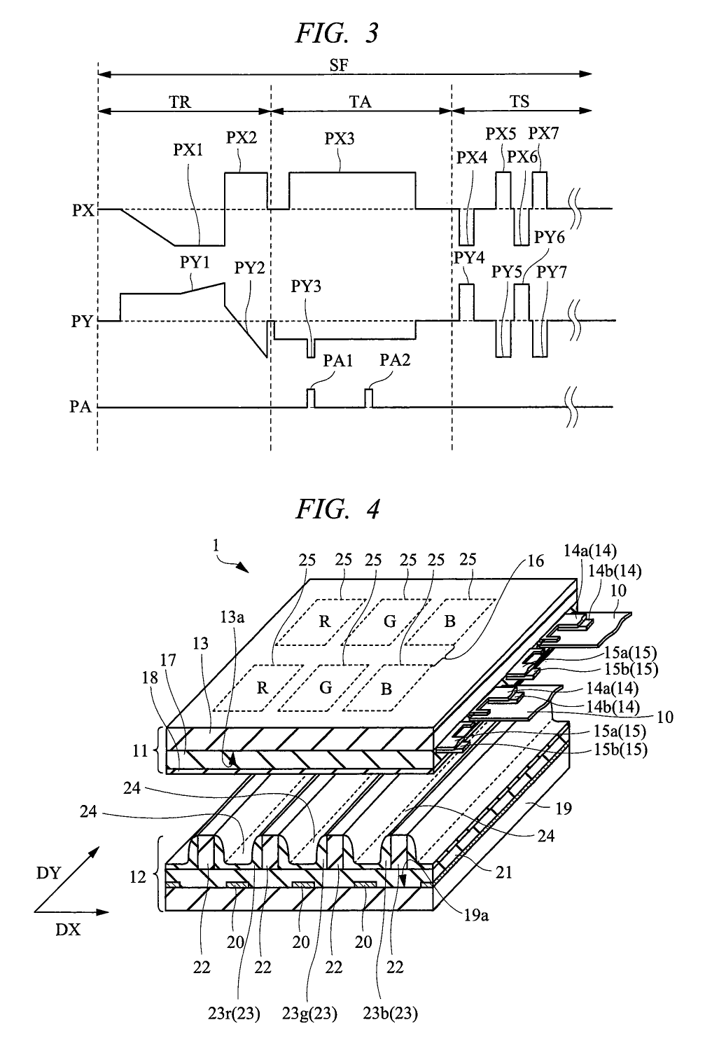

FIG. 1 is a block diagram schematically showing an overall configuration of one example of the PDP device embedding a PDP of the first embodiment. FIG. 2 is an explanatory diagram showing one example of a grayscale drive sequence in the PDP device shown in FIG. 1. FIG. 3 is an explanatory diagram showing one example of a drive waveform of the PDP device shown in FIG. 1.

While the detailed structure of the PDP 1 shown in FIG. 1 will be described later, the PDP 1 is configured by an X electrode (first electrode, sustain electrode) 14, a Y electrode (second electrode, scan electrode) 15, an address electrode (third electrode) 20, etc. To apply a voltage across respective electrodes (14, 15, and 20), an address driving circuit (third electrode driving circuit) ADRV, a Y scan driver YSCDRV, a Y driving circuit (second electrode driving circuit, second sustain driver) YSUSDRV, and an X driving circuit (first electrode driving circuit, first sustain driver) XSUSDRV are electrically connected to the PDP 1. The PDP 1 also includes a control circuit CNT for controlling each driving circuit (driver).

The PDP 1 has formed therein: a display line by the X electrodes (X1, X2, X3, . . . , Xn) 14 and the Y electrodes (Y1, Y2, Y3, . . . , Yn) 15 alternately provided so as to perform the sustain discharge (display discharge); and a cell of a matrix pattern is formed at every intersection of the display electrode pairs configured by pairs of the X electrode 14 and the Y electrodes 15 and the address electrodes (A1, A2, A3, . . . , An) 20 substantially orthogonal to the display electrode pair (display line).

The Y scan driver YSCDRV controls the Y electrode 15 and sequentially selects the Y electrodes (display line) 15 in an address step TA (see FIG. 2) and allows the address discharge to be generated between the address electrode 20 electrically connected with the address driving circuit ADRV and each Y electrode 15 for selecting on and off of the cell for each of subfields SF1 to SFn (see FIG. 2).

The Y driving circuit YSUSDRV and the X driving circuit XSUSDRV allow sustain discharges (sustain discharges) for the number of times according to a weighting of each subfield to be generated for the cell selected by the address discharge in a display step TS (see FIG. 2).

The control circuit CNT outputs, for example, a control signal appropriate to each driving circuit (driver) from the image data and the signal inputted from an external device such as a TV tuner and a computer, thereby playing a role of performing a predetermined image display.

As shown in FIG. 2, the grayscale drive sequence in the PDP device configures one field (frame) F1 by a plurality of subfields (subframes) SF1 to SFn respectively having a weighting of a predetermined brightness and performs a desired grayscale display by combinations of each of the subfields SF1 to SFn.

To describe a configuration example of the plurality of subfields, for example, a display of 256 grayscales is performed by eight subfields SF1 to SF8 (a ratio of the numbers of times of the sustain discharge is 1:2:4:8:16:32:64:128) each having a brightness weighting of a power of two. It is needless to say that the number of subfields and weightings of respective subfields can be variously combined.

Each of the subfields SF1 to SFn is formed by a reset step (reset period) TR making the wall charges of all the cells in each display region uniform, an address step (address period) TA selecting the On cell, and a display step (sustain discharge period) TS allowing the selected cell to discharge (On) by the number of times only according to the brightness (weighting of each subfield), and the cell is allowed to be On according to the brightness for every display of each subfield, and the display of one field is performed by displaying, for example, eight subfields (SF1 to SF8).

Next, one example of drive waveforms is shown in FIG. 3. Shown in FIG. 3 is examples of a drive waveform (PX, PY, PA) applied to each electrode (X electrode 14, Y electrode 15, and address electrode 20) shown in FIG. 1 in each of the subfields SF1 to SFn shown in FIG. 2.

First, as a first step, in the reset step TR, between the X electrode 14 (see FIG. 1) and the Y electrode 15 (see FIG. 1), the reset discharge is generated, so that all the cells are formed with charges (wall charges), thereby performing the reset (to be put into a state to prepare for the next address operation period) of all the cells.

In this reset step TR, for example, as shown in FIG. 3, the Y electrode 15 is applied with a positive Y-write dull wave PY1, and the X electrode 14 is applied with a negative X voltage PX1, configuring each display electrode pair of the PDP 1. As a result, the X electrode 14 becomes a cathode, and the Y electrode 15 becomes an anode, so that a reset discharge is generated between both the electrodes, and the wall charges are formed to all the cells.

Subsequently, a Y compensation dull wave PY2 and an X compensation voltage PS2 that erase the wall charges formed to the cell with leaving a necessary amount of the wall charges are applied. As a result, the amount of the wall charges formed in all the cells is made substantially uniform.

In this manner, in the reset step TR, as a voltage waveform for generating the reset discharge, a relatively modest waveform as compared with repeating sustain pulses PX5, PX6, PX7, PY5, PY6, and PY7 to be described later and similar to the Y-write dull wave PY1 and the X voltage PX1 is applied, so that the reset discharge can be prevented from being an excessive discharge state.

Next, as a second step, in the address step TA, between the address electrode 20 (see FIG. 1) and the Y electrode 15, an address discharge is generated for the cell for selecting turning on, so that on/off of the cell is selected. The subsequent discharge (sustain discharge and display discharge) at the display electrode (X electrode 14 and Y electrode 15) pair is generated.

In this address step TA, for example, as shown in FIG. 3, to perform a discharge to decide a display cell in the column direction, the Y electrode 15 is applied with a scan pulse PY3, and the X electrode 14 is applied with an X voltage PX3. This scan pulse PY3 is applied with the timing shifted per every column.

On the one hand, to perform a discharge for deciding a display cell in the row direction, the address electrode 20 is applied with address pulses PA1 and PA2. These address pulses PA1 and PA2 are applied corresponding to the scan pulse PY3 applied to every column, and is applied at a timing to generate the discharge in the cell desired to be displayed formed at the intersection of the Y electrode 15 and the address electrode 20.

Next, as a third step, in the display step TS, a sustain discharge (display discharge, sustain discharge) is sustained between the X electrode 14 and the Y electrode 15 of the cell selected to be on, so that the cell emits during a predetermined period.

In this display step TS, for example, as shown in FIG. 3, first sustain pulses PX4 and PY4 having different electrical polarities are applied to the X electrode 14 and the Y electrode 15, respectively. As a result, the discharge state between the display electrode pair is sustained.

Subsequently, the X electrode 14 and the Y electrode 15 are repeatedly applied with the repeating sustain pulses PX5, PX6, PX7, PY5, PY6, and PY7 having mutually different electrical polarities, so that the discharge state between the display electrode pair is further sustained.

As shown in FIG. 3, the electrical polarities of the sustain pulses PX4, PX5, PX6, and PX7 as well as the sustain pulses PY4, PY5, PY6, and PY7 are alternately counterchanged. That is, the X electrode 14 and the Y electrode 15, at the time of sustain charge, are alternately made to be the cathode or the anode, thereby repeatedly performing discharges.

While the overall structure of the PDP device of the first embodiment and the example of the method of grayscale drive have been described as above, it is needless to say that various modification examples are applicable. For example, in the drive waveform described in FIG. 3, the electrical polarity of the pulse or the voltage to be applied may be reversed. In this case, in the reset step TR shown in FIG. 3, the X electrode 14 becomes the anode, and the Y electrode 15 becomes the cathode. Further, for example, in addition to the drive waveform shown in FIG. 3, a voltage waveform for erasing the wall charges at the last stage of the display step TS may be added.

<Basic Structure of PDP>

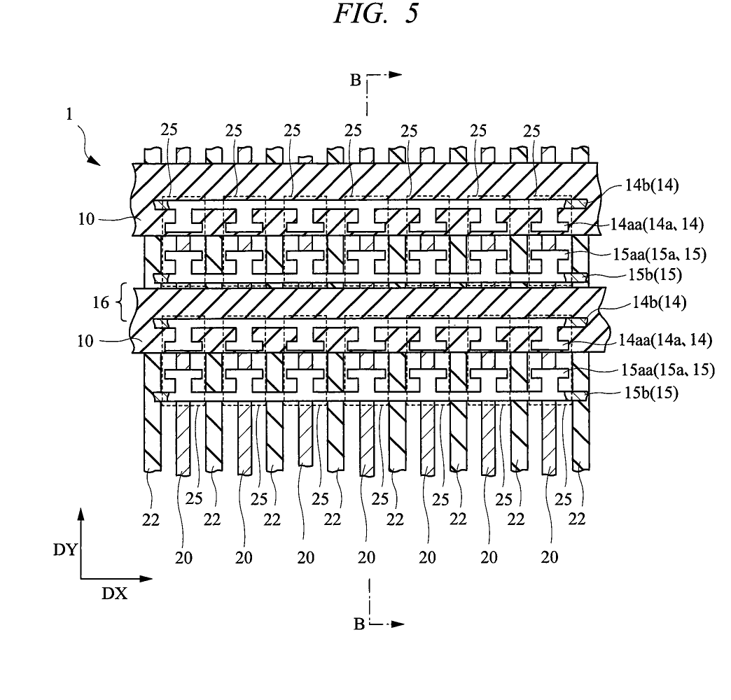

Next, with reference to FIG. 4 and FIG. 5, one example of the structure of the PDP of the first embodiment will be described with taking a surface discharge AC-type PDP as an example. FIG. 4 is an enlarged exploded perspective view of main parts of the PDP of the first embodiment, and FIG. 5 is an enlarged plan view of main parts seen from the display surface side showing a two-dimensional positional relationship among an electrode group, a barrier rib, and a light absorbing layer.

In FIG. 5, to make the positional relationship among an electrode group, a barrier rib, and a light absorbing layer comprised in the PDP understandable, illustrations of other members are omitted.

In FIG. 4, the PDP 1 has a front substrate structure (first substrate structure) 11 and a rear substrate structure (second substrate structure) 12. The front substrate structure 11 and the rear substrate structure 12 are superposed opposing to each other, and a discharge space 24 is formed between both the structures.

The front substrate structure 11 has a display surface of the PDP 1, and has a front substrate (substrate, first substrate) 13 mainly made of glass at the display surface side. The surface 13a at the opposite side of the display surface of the front substrate 13 is formed with a plurality of X electrodes (first electrode, sustain electrode) 14 serving as the display electrode of the PDP 1 and a plurality of Y electrodes (second electrode, scan electrode) 15, respectively.

The X electrode 14 and the Y electrode 15 form a pair of the display electrode for performing the sustain discharge (display discharge, sustain discharge), and for example, are alternately disposed, respectively, so as to extend along the column direction (first direction, horizontal direction) DX. This one pair of the X electrode 14 and the Y electrode 15 forms a display column in the PDP 1.

In general, the X electrode 14 and the Y electrode 15 are formed of, for example, an X transparent electrode (transparent electrode portion) 14a and a Y transparent electrode (transparent electrode portion) 15a comprising a transparent electrode material such as ITO (Indium Tin Oxide) and SnO₂, and an X bus electrode (metal electrode portion) 14b and a Y bus electrode (metal electrode portion) 15b comprising, for example, Ag, Au, Al (aluminum), Cu, Cr or a layered body thereof (for example, a layered body of Cr/Cu/Cr).

For stability of the sustain discharge and improvement of the discharge efficiency, the X transparent electrode 14a and the Y transparent electrode 15a are formed, for example, as shown in FIG. 5, so as to have protruded portions 14aa and 15aa respectively protruding in the opposing directions from the positions superposing an X bus electrode 14b and a Y bus electrode 15b so that the shortest distance between one electrode pair (referred to as a discharge gap) gets close locally corresponding to the position of the cell 25.

The positions at which the protruded portions 14aa and 15aa of the X transparent electrode 14a and the Y transparent electrode 15a are formed correspond to the inside of the cell 25 of the PDP 1, and thus the X transparent electrode 14a and the Y transparent electrode 15a are formed of a transparent electrode material in order to allow visible light emitted from a phosphor 23 to be described later to transmit and to be extracted on the display surface side.

Consequently, the X transparent electrode 14a and the Y transparent electrode 15a, and the X bus electrode 14b and the Y bus electrode 15b are different in transmissivity for the visible light emitted from the phosphor 23 to be described later, and the transmissivity of the X transparent electrode 14a and the Y transparent electrode 15a is higher than that of the X bus electrode 14b and the Y bus electrode 15b.

In FIG. 5, as an example of the shapes of the protruded portions 14aa and 15aa respectively comprised by the X transparent electrode 14a and the Y transparent electrode 15a, though a T type shape is shown, the protruded portions are not limited to this shape, but are applicable to various modified shapes.

For example, the edge of the protruded portion is not the T-type, but may be simply of an I-type. Further, there is also an electrode structure in which the protruded portions 14aa and 15aa are not formed on the X transparent electrode 14a and the Y transparent electrode 15a, but belt-like X transparent electrode 14a and the Y transparent electrode 15a having a wider width than that of the X bus electrode 14b and the Y bus electrode 15b are formed.

On the one hand, the X bus electrode 14b and the Y bus electrode 15b are formed so as to reduce the electric resistance of the X electrode 14 and the Y electrode 15, and are formed of a metal material lower in electric resistance than the X transparent electrode 14a and the Y transparent electrode 15a.

Since the X bus electrode 14b and the Y bus electrode 15b are formed of a metal material in this manner, transmissivity for the visible light is lower as compared with the X transparent electrode 14a and the Y transparent electrode 15a. Consequently, to allow the visible light emitted from the phosphor 23 to be described later to transmit and to be efficiently extracted on the display surface side, the X bus electrode 14b and the Y bus electrode 15b are preferably formed in a bar shape as shown in FIG. 5, so that the area of the region where the X bus electrode 14b and the Y bus electrode 15b superpose with the cell 25 is made small.

Further, as shown in FIG. 5, between the adjacent two pairs of the display electrode pair (pair of the X electrode 14 and the Y electrode 15), a non-discharge gap 16 not contributing to the display emission of the PDP 1 is formed. The non-discharge gap 16 is formed along the column direction DX.

Further, as shown in FIG. 4, these electrode groups (X electrode 14, Y electrode 15) are covered by, for example, a dielectric layer 17 made of a low-melting glass material as a main component. Between the surfaces of the dielectric layer 17 and the X electrode 14, a light absorbing layer 10 is selectively formed. The detailed structure and function of this light absorbing layer 10 will be described later.

The surface of the dielectric layer 17 is formed with a protective layer 18 for protecting the dielectric layer 17 from shock by an impact (sputtering) of the ions and the like generated at the time of sustain discharge described above. The protective layer 18 is formed so as to cover one surface of the dielectric layer 17. Since the protective layer 18 requires a high sputtering resistance and a secondary electron discharge coefficient, for example, a material mainly made of MgO (magnesium oxide) can be used.

On the one hand, the rear substrate structure 12 shown in FIG. 4 has a rear substrate (substrate, second substrate) 19 mainly made of glass. On the surface (second surface, inner side surface) opposed to the front substrate structure 11 of the rear substrate 19, a plurality of address electrodes (third electrodes) 20 are formed. Each address electrode 20 is formed so as to extend along the row direction (second direction, vertical direction) DY crossing (approximately orthogonal to) the direction to which the X electrode 14 and the Y electrode 15 extend. Each address electrode 20 is disposed having a predetermined spacing so as to be in parallel with each other.

As a material forming the address electrode 20, for example, Ag, Au, Al (aluminum), Cu, Cr or a layered body thereof (for example, the layered body of Cr/Cu/Cr) and the like can be used.

This address electrode 20 and the Y electrode 15 formed to the front substrate structure 11 configure an electrode pair for performing an address discharge which is a discharge for selecting On/Off of the cell 25. That is, the Y electrode 15 carries a function as a sustain discharge electrode and a function as an address discharge electrode (scan electrode) together.

The address electrode 20 is covered by a dielectric layer 21. On the dielectric layer 21, a plurality of barrier ribs 22 (first barrier rib, vertical rib) extending in the thickness direction of the rear substrate structure 12 are formed. The barrier rib 22 is formed so as to extend on the line along the row direction DY to which the address electrode 20 extends. The planar position of the barrier rib 22, as shown in FIG. 4, is disposed between the adjacent address electrodes 20. By disposing the barrier rib 22 between the adjacent address electrodes 20, a discharge space 24 partitioning the surface of the dielectric layer 21 along the row direction DY corresponding to the position of each address electrode 20 is formed.

On the upper surface of the dielectric layer 21 on the address electrode 20 and at the side surface of the barrier rib 22, the phosphors 23r, 23g, and 23b excited by vacuum ultraviolet ray and generating the visible light of each color of red (R), green (G), and blue (B) are formed respectively at a predetermined position.

The front substrate structure 11 and the rear substrate structure 12 shown in FIG. 4 are fixed in a state in which the surface on which the protective layer 18 is formed and the surface on which the barrier rib 22 is formed are opposed to each other. Further, the peripheral portion (not shown) of the PDP 1 is sealed by a sealing material such as a low-melting glass material, for example, referred to as a frit, and the inside of the discharge space 24 is filled with a gas (for example, a mixed gas of Ne and Xe) referred to as a discharge gas (not shown) at a predetermined pressure.

As shown in FIG. 5, one piece of the cell 25 is formed corresponding to an intersection of a pair of the X electrode 14 and the Y electrode 15 and the address electrode 20. The plane area of the cell 25 is regulated by a spacing of the pair of the X electrode 14 and the Y electrode 15 and the spacing of the barrier rib 22.

Each cell 25 is formed with any of the red phosphor 23r, the green phosphor 23g, and the blue phosphor 23b shown in FIG. 4, respectively.

By a set of respective cells 25 of the R, G, and B, a pixel is formed. That is, each of the phosphor 23r, 23g, and 23b is a light emitting element of the PDP 1, and the visible light of each color of red (R), green (G), and blue (B) is emitted by exciting the phosphor by vacuum ultraviolet ray of a predetermined wavelength generated by the sustain discharge.

The PDP 1 is structured such that the sustain discharge is generated for every cell 25, and each of the phosphor 23r, 23g, and 23b is excited and emit light by the vacuum ultraviolet ray generated by the sustain discharge.

<Detailed Structure of Light Absorbing Layer>

Next, a detailed structure and a function of the light absorbing layer 10 shown in FIGS. 4 and 5 will be described with reference to FIGS. 4 to 8.

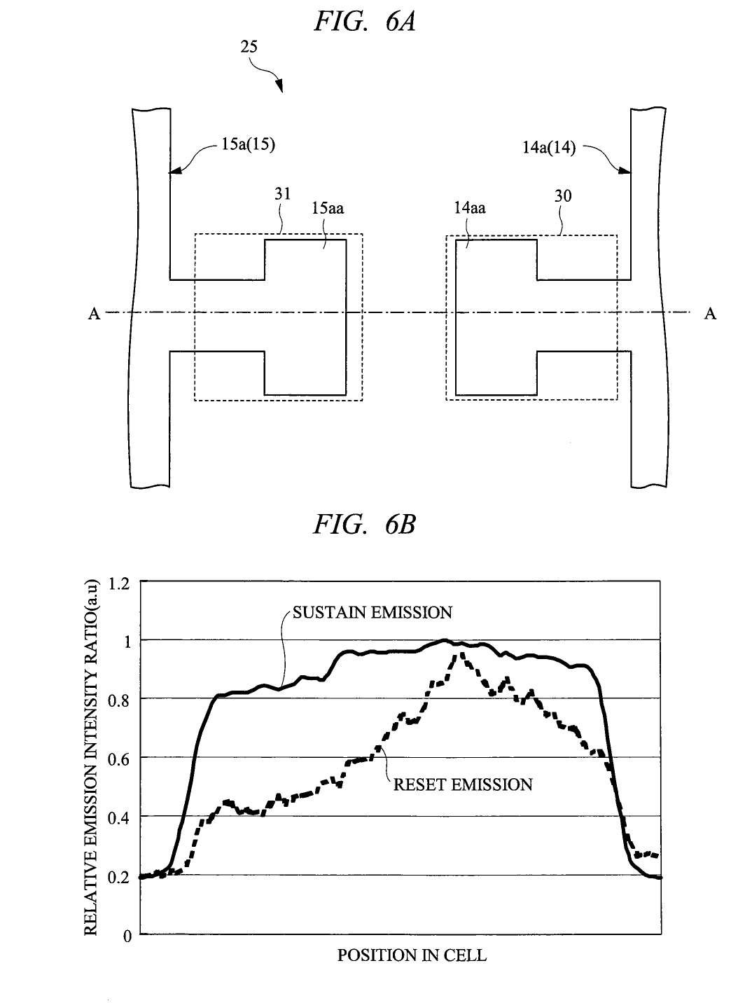

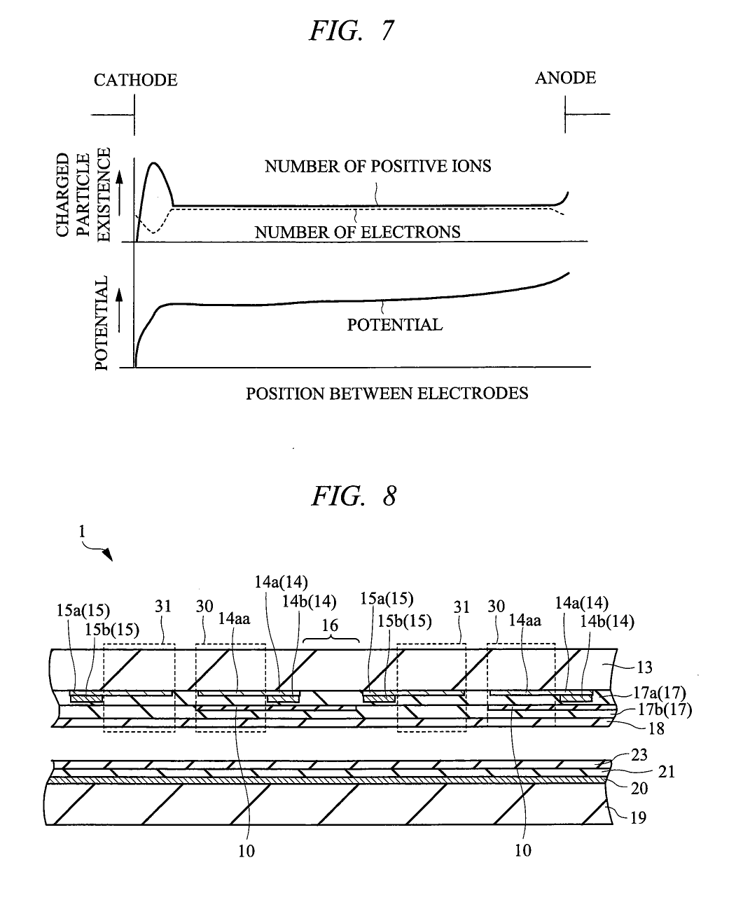

FIG. 6 is an explanatory diagram showing a distribution (at the time of reset discharge and at the time of sustain discharge) of emission intensity inside one cell in a state where the light absorbing layer of the PDP shown in FIG. 5 is not formed, and FIG. 7 is an explanatory diagram showing an electrical potential distribution inside one sell in a state where the light absorbing layer of the PDP shown in FIG. 5 is not formed and an existing probability distribution of positive ions and electrons. FIG. 8 is an enlarged cross-sectional view of main parts showing a cross section along the line B-B shown in FIG. 5.

First, the inventors of the present invention have studied on the distribution of the emission intensity inside one cell comprised in the PDP at the time of reset discharge and the sustain discharge, and the result found out from the study will be described with reference to FIG. 6.

FIG. 6A is an enlarged plan view of main parts showing one piece of the cell 25 in a state where the light absorbing layer 10 of the PDP shown in FIG. 5 is not formed. FIG. 6B shows a distribution of the emission intensity inside the cell in the cross section along the line A-A shown in FIG. 6A, and shows a relative emission intensity ratio (a.u) in the axis of ordinate, and a position inside the cell corresponding to a plan view shown in FIG. 6A in the axis of abscissas. FIG. 6B shows the emission intensity (reset emission) of the visible light at the time of reset discharge by solid line, and the emission intensity (sustain emission) of the visible light at the time of sustain discharge by dotted line.

In FIG. 6, it is apparent that a first region 30 superposed with the X transparent electrode 14a in the thickness direction has a distribution of the emission intensity of the visible light at the time of reset discharge approximately 1.5 times larger than a second region 31 superposed with the Y transparent electrode 15a in the thickness direction.

On the one hand, the distribution of the emission intensity of the visible light at the time of sustain discharge has no large difference between the first region 30 and the second region 31, and becomes a substantially uniform emission intensity distribution.

In other words, at the time of the sustain discharge and at the time of the reset discharge, the distribution of the emission intensity inside the cell 25 is different, and the emission intensity of the visible light at the time of reset discharge is strong deflected to the X transparent electrode 14a side.

Next, the reason why the distribution of the emission intensity inside the cell 25 is different between the sustain discharge and the reset discharge will be described with reference to FIG. 7.

FIG. 7 is an explanatory diagram showing a potential distribution between the anode and the cathode and an existing probability distribution of charged particles, and shows the position between the anode and the cathode (cathode at the left side and the anode at the right side) in the axis of abscissas, and shows the potential in the lower step in the axis of ordinate, and the existing probability of respective charged particles (positive ions and electrons) in the upper step.

As shown in FIG. 7, the potential distribution between the cathode and the anode abruptly rises in the vicinity of the cathode, and after that, shows a nearly constant potential up to the anode. Since the gas (positive ion) ionized by the discharge is positively charged, it exists intensively in large quantity in the vicinity of the cathode.

Meanwhile, the emission principle of the PDP is such that a phosphor is excited and emits light by the ultraviolet ray radiated when a gas ionized by the discharge (positive ion) transits to a normal state. Consequently, in the region in the vicinity of the cathode where the positive ions intensively exist, this ultraviolet ray is generated in large quantity, and the emission intensity of the region in the vicinity of the cathode becomes intensified as compared with the emission intensity in the vicinity of the anode.

When this phenomenon is applied to the cell 25 described in FIG. 6, first, at the time of reset discharge, the X transparent electrode 14a shown in FIG. 6A becomes a cathode, and the Y transparent electrode 15a becomes an anode. Therefore, the vicinity of the X transparent electrode 14a which is a cathode, that is, the first region 30 superposed with (opposed to) the X transparent electrode 14a in the thickness direction becomes higher in the photoluminescent brightness than the vicinity of the Y transparent electrode 15a which is the anode, that is, the second region 31 superposed with the Y transparent electrode 15a in the thickness direction.

On the other hand, at the time of sustain discharge, as described above, the X transparent electrode 14a and the Y transparent electrode 15a become alternately a cathode or an anode, thereby repeatedly performing the discharge. Therefore, the gas ionized by the discharge does not exist deflected to any one of the regions, but is substantially distributed. Consequently, as shown in FIG. 6B, the distribution of the emission intensity of the visible light at the time of sustain discharge has no large difference between the first region 30 and the second region 31, and becomes substantially uniform emission intensity distribution.

From the result above, by making the visible light transmissivity (first visible light transmissivity) of the first region 30 lower than the visible light transmissivity (second visible light transmissivity) of the second region 31, the transmissivity of the visible light generated at the time of reset discharge can be lowered. On the other hand, at the time of sustain discharge forming the display image, the X electrode 14 and the Y electrode 15 alternately becomes the cathode or the anode so as to repeatedly perform the discharge, thereby enabling the distribution of the emission intensity of the visible light to be substantially the same. Therefore, by making the visible light transmissivity (second visible light transmissivity) of the second region 31 higher than the visible light transmissivity (first visible light transmissivity) of the first region 30, the visible light can be efficiently extracted from the second region 31, and thus, a lowering of the transmissivity of the PDP 1 can be suppressed. In other words, as well as a lowering of the brightness of the PDP 1 can be suppressed, the contrast can be improved.

The first visible light transmissivity of the first region 30 is made to be lower than 90%, which is the visible light transmissivity (that is, the second visible light transmissivity) of the X transparent electrode 14a and the Y transparent electrode 15a. Further, to allow sustain emission to be transmitted, the transmissivity is preferably made about 50% or more. The lower limit of the visible light transmissivity is a design item which varies according to the adjusting means of the visible light transmissivity, and is not limited to this value.

Next, the detailed structure of the light absorbing layer 10 serving as the adjusting means of the visible light transmissivity of the first embodiment will be described with reference to FIGS. 4 to 8.

As shown in FIG. 8, in the first embodiment, the first region 30 is selectively formed with the light absorbing layer 10 as the adjusting means of the visible light transmissivity. The light absorbing layer 10, for example, is formed of a light absorbing material such as a black pigment. Alternatively, a material formed of the low-melting glass that is a constituent material of the dielectric layer 17 in which particles of the light absorbing material are dispersed can be also used. The content of the light absorbing material in the light absorbing layer 10 can be appropriately selected according to the desired visible light transmissivity.

As a preferable material to be used for the light absorbing layer 10, the particles of black pigment such as titanium oxide, black iron oxide, chrome oxide, manganese oxide, carbon black, and ultramarine blue pigment can be used. These black pigments can be used by one kind or mixing two or more kinds.

The first region 30 is selectively formed with the light absorbing layer 10 as the adjusting means of the visible light transmissivity, so that the visible light transmissivity of the first region 30 can be easily adjusted according to the light absorption characteristic of the light absorbing material contained in the light absorbing layer 10 and its content ratio.

The arrangement in the planar direction of the light absorbing layer 10 is formed so as to include the first region 30 shown in FIG. 8, and is formed in a belt-like shape so as to extend along the column direction DX as shown in FIG. 5.

By forming the light absorbing layer 10 so as to include the first region 30 in this manner, the X electrode 14 which becomes a cathode at the time of reset discharge is covered by the light absorbing layer 10. Therefore, the visible light transmissivity of the first region 30 can be lowered as compared with the visible light transmissivity of the second region 31.

Further, by forming the light absorbing layer 10 in a belt-like shape, across the whole of the display screen of the PDP 1 (see FIG. 5), the light absorbing layer 10 is formed in a stripe pattern. When the light absorbing layer is formed by the stripe pattern, since a positional shift toward the column direction (line direction) DX can be prevented as compared with the case where the layer is formed by a matrix pattern for each sub-pixel (cell 25) or each pixel (a set of respective cells 25 of R, G, and B), the alignment with the front substrate structure 11 and the rear substrate structure 12 becomes easy in manufacturing of the PDP 1.

Here, the emission intensity distribution at the time of reset discharge becomes larger as approaching the edge of the protruded portion 14aa of the X transparent electrode 14a in the entire first region 30 shown in FIG. 6. Consequently, the planar position of the first region 30, that is, the planar position forming the light absorbing layer 10 preferably includes a region superposed with the edge of the protruded portion 14aa of the X transparent electrode 14a in the thickness direction. As a result, the visible light transmissivity of the position at which the emission intensity at the time of reset discharge is the highest can be lowered.

The light absorbing layer 10 disposed in the thickness direction is formed between the surface of the dielectric layer 17 and the X electrode 14. By forming the light absorbing layer 10 between the surface of the dielectric layer 17 and the X electrode 14, the light absorbing layer 10 can be formed after the X electrode 14 is formed, and therefore, the alignment with the X electrode 14 can be easily made.

Further, as shown in FIGS. 5 and 8, a width of the light absorbing layer 10 is formed so as to extend from the edge of the protruded portion 14aa of the X transparent electrode 14a to the non-discharge gap 16. By forming the width of the light absorbing layer 10 so as to extend to the non-discharge gap 16 in this manner, the reflection of the external light incident on the non-discharge gap 16 can be suppressed. Consequently, the dark room contrast of the PDP 1 can be reduced.

### FIRST MODIFICATION EXAMPLE

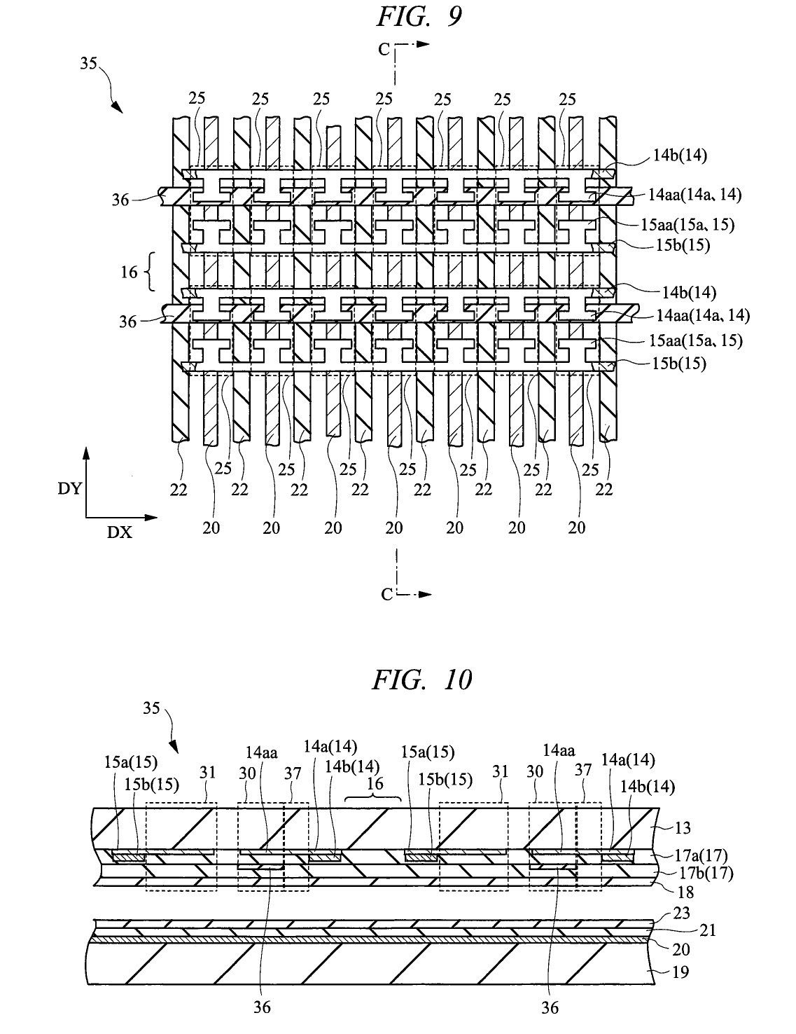

In the first embodiment, descriptions have been made on the example of forming the light absorbing layer 10 in a belt shape so as to cover the whole region that is superposed with the X electrode 14 in the thickness direction. However, the planar shape of the light absorbing layer 10 is not limited to this, and various modification examples are applicable. Hereinafter, a first modification example of the first embodiment will be described with reference to FIGS. 9 and 10.

FIG. 9 is an enlarged plan view of main parts seen from the display surface side showing a two-dimensional positional relationship among the electrode group, the barrier rib, and the light absorbing layer comprised in a PDP which is a modification example, and FIG. 10 is an enlarged cross-sectional view of main parts showing a cross section along the line C-C shown in FIG. 9. A light absorbing layer 36 shown in FIGS. 9 and 10 is same as the light absorbing layer 10 described in FIGS. 4, 5, and 8 except for the planar shape, and therefore, repetitive descriptions thereof will be omitted.

The difference between a PDP 35 shown in FIG. 9 and the PDP 1 shown in FIG. 5 is in the planar shape of the light absorbing layer 36. That is, the light absorbing layer 36 comprised in the PDP 35 shown in FIG. 9 is formed such that the width of the light absorbing layer 36 formed in a belt-like shape is shorter than the length (length in the direction proceeding to a pair of the Y electrodes) of the protruded portion 14aa of the X transparent electrode 14a.

In this manner, the PDP 35 forms the width of the light absorbing layer 36 shorter than the length of the protruded portion 14aa of the X transparent electrode 14a, so that it is structured such that a third region 37 higher in visible light transmissivity than the first region 30 is disposed adjacent to the first region 30 between the edge of the protruded portion 14aa and the X bus electrode 14b.

Here, as described in FIG. 6, the emission intensity distribution at the time of reset discharge becomes larger as approaching the edge of the protruded portion 14aa of the X transparent electrode 14a in the entire first region 30 shown in FIG. 6. On the other hand, the emission intensity distribution at the time of sustain discharge shows a substantially uniform emission intensity distribution in the region formed with the protruded portion 14aa of the X transparent electrode 14a.

Consequently, by including a region superposed with the edge of the protruded portion 14aa of the X transparent electrode 14a in the thickness direction in the first region 30 where the visible light transmissivity is low, the visible light transmissivity of the position at which the emission intensity at the time of reset discharge is the highest can be lowered. On the other hand, a structure is made such that the third region 37 which is higher in visible light transmissivity than the first region 30 is provided between the edge of the protruded portion 14aa and the X bus electrode 14b, so that the emission at the time of sustain discharge can be extracted from the third region 37 in addition to the second region 31; therefore, the photoluminescent brightness can be further improved as compared with the PDP 1 described in the first embodiment.

### SECOND MODIFICATION EXAMPLE

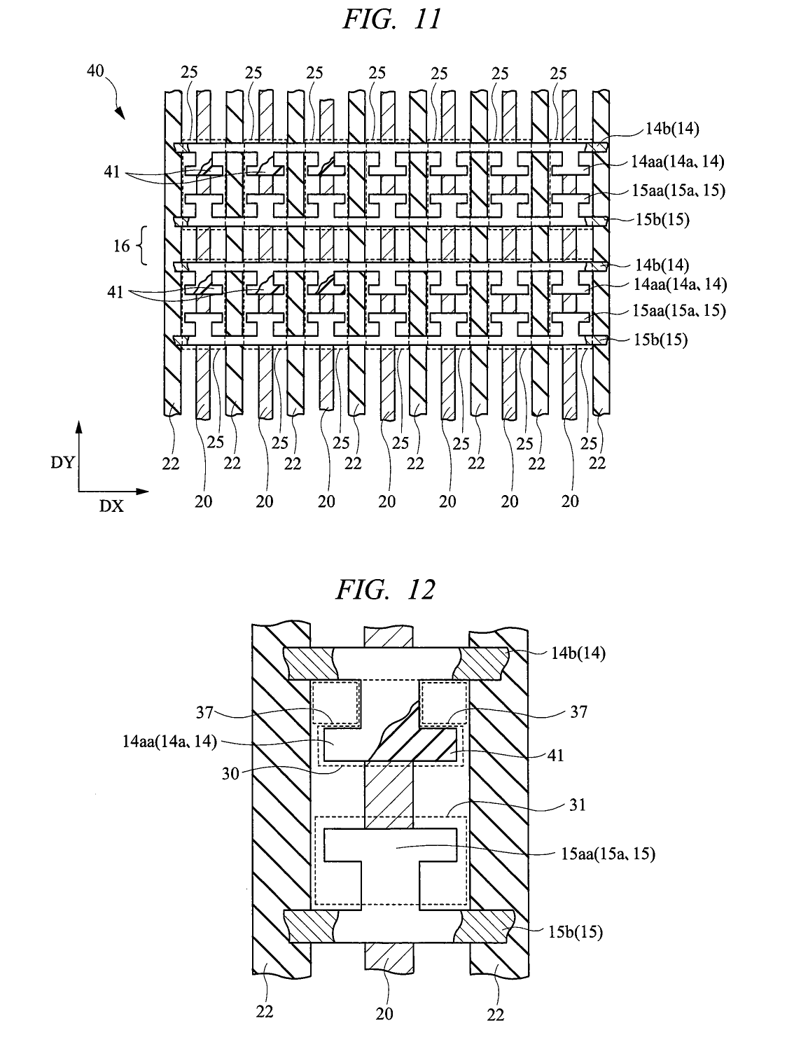

Next, a second modification example of the first embodiment will be described with reference to FIGS. 11 and 12. FIG. 11 is an enlarged plan view of main parts seen from the display surface side showing a two-dimensional positional relationship among the electrode group, the barrier rib, and the light absorbing layer comprised in the PDP which is the second modification example of the first embodiment. FIG. 12 is an enlarged plan view of main parts showing one piece of the cell 25 of the PDP shown in FIG. 11.

A light absorbing layer 41 shown in FIGS. 11 and 12 is the same as the light absorbing layer 10 described in FIGS. 4, 5, and 8 except for the planar shape, and therefore, the description thereof will be omitted.

The difference between a PDP 40 shown in FIG. 11 and the PDP 1 shown in FIG. 5 is a planar shape of a light absorbing layer 41. That is, the light absorbing layer 41 comprised in a PDP 40 shown in FIG. 11 is not formed in the belt-like shape, but is selectively formed along the shape of the protruded portion 14aa of the X transparent electrode 14a so as to cover the protruded portion 14aa.

Here, as described in FIG. 7, the positive ions at the time of reset discharge are concentrated in the vicinity of the X electrode 14 which becomes a cathode. Therefore, at the time of reset discharge, the photoluminescent brightness of the region superposed with the protruded portion 14aa of the X transparent electrode 14a in the thickness direction becomes particularly intensified.

In the PDP 40, the light absorbing layer 41 is formed along the shape of the protruded portion 14aa of the X transparent electrode 14a, so that the range of the first region 30 that lowers the visible light transmissivity is restricted to the minimum range where the first region 30 is superposed with the protruded portion 14aa of the X transparent electrode 14a in the thickness direction.

Therefore, the structure is such that the third region 37 higher in visible light transmissivity than the first region 30 is disposed adjacent to the first region 30 between the edge of the protruded portion 14aa and the X bus electrode 14b.

In this manner, by being structured such that the third region 37 higher in visible light transmissivity than the first region 30 is provided between the edge of the protruded portion 14aa and the X bus electrode 14b, the emission at the time of sustain discharge and can be also extracted from the third region 37 in addition to that from the second region 31, and therefore, the lowering of photoluminescent brightness can be further suppressed as compared with the PDP 1 described in the first embodiment.

Since the light absorbing layer 41 is formed in the belt-like shape along the column direction DX similarly to the light absorbing layer 10 shown in FIG. 5, at the time of forming the light absorbing layer 41, the displacement in the column direction DX can be prevented.

<Manufacturing Method of PDP>

Next, an outline of a manufacturing method of the PDP 1 of the first embodiment will be described with reference to FIGS. 4, 5, and 8. The manufacturing method of the PDP 1 of the first embodiment includes the following steps.

a) First, the front substrate structure 11 shown in FIG. 4 is formed. To form the front substrate structure 11, for example, the following steps are included.

First, the front substrate (first substrate) 13 is prepared, and the X electrode 14 and the Y electrode 15 are formed on a surface (first surface) 13a of an opposite side of the display surface 13. The X electrode 14 and the Y electrode 15 are formed as follows, for example.

First, the front substrate (first substrate) 13 is prepared, and on a surface (first surface) 13 of an opposite side of the display surface, the X transparent electrode 14a and the Y transparent electrode 15a, for example, made of ITO and SnO₂, are formed, for example, in a desired pattern as shown in FIG. 5 by using photolithography technique and etching technique.

Next, on the X transparent electrode 14a and the Y transparent electrode 15a, the X bus electrode 14b and the Y bus electrode 15b are formed, respectively. A thick-film formation technique such as a screen printing is used when the material used for the X bus electrode 14b and the Y bus electrode 15b is Ag and Au, and a thin-film formation technique such as an evaporation method and a sputtering method as well as an etching method are used with respect to other metals (Al, Cu, Cr and the layered body thereof), so that the electrodes 14b and 15b can be formed in the predetermined number of pieces, thickness, width, and intervals.

Next, after the X electrode 14 and the Y electrode 15 are formed on the surface 13a of the front substrate 13, the dielectric layer 17 for covering the X electrode 14 and the Y electrode 15 is formed on the front substrate 13. The dielectric layer 17, for example, can be formed by coating and baking a frit paste (hereinafter, referred to as a low-melting glass paste) of a low-melting glass powder as a main component on the front substrate 13 by the screen printing. There is also a method of pasting and baking a sheet-like dielectric layer 17 on the front substrate 13. Alternatively, the dielectric layer 17 may be formed by forming a SiO₂ film by a plasma CVD method.

Here, in the first embodiment, since the light absorbing layer 10 or the light absorbing layer 36 (see FIG. 9) or the light absorbing layer 41 (see FIG. 11) (hereinafter, simply referred to as the light absorbing layers 10, 36, and 41) is formed between the surface of the dielectric layer 17 and the X electrode 14, the formation of the dielectric layer 17 is performed divided into two steps. That is, the dielectric layer 17 is turned into a two-layer structure of a first dielectric layer 17a and a second dielectric layer 17b shown in FIG. 8, and between them, the light absorbing layers 10, 36, and 41 are formed.

Describing by an example using the screen printing method, first, the front substrate 13 is coated relatively thin with the low-melting glass paste, and is fired, and the first dielectric layer 17a shown in FIG. 8 is formed. Next, the light absorbing layers 10, 36 and 41 of the predetermined shape are coated on the surface of the first dielectric layer 17a by the screen printing method, and are fired, thereby forming the absorption layers. Here, for example, when the light absorbing layer 10 shown in FIG. 5 is to be formed, it is formed in the belt-like shape along the column direction DX so as to cover the X electrode 14. When the light absorbing layer 36 shown in FIG. 9 is formed, it is formed in the belt-like shape along the column direction DX so as to cover a crossing position with the protruded portion 14aa of the X transparent electrode 14a. Further, when the light absorbing layer 41 shown in FIG. 11 is to be formed, it is formed along the shape of the protruded portion 14aa of the X transparent electrode 14a so as to cover the protruded portion. By forming the light absorbing layers 10, 36, and 41 as described above, the region in which the light absorbing layers 10, 36, and 41 are formed becomes the first region 30 low in visible light transmissivity. After that, the low-melting glass paste is coated and fired again so as to be able to obtain the dielectric layer having a necessary thickness, thereby forming the second dielectric layer 17b.

By dividing such a formation step of the dielectric layer 17 into two steps, the light absorbing layers 10, 36, and 41 can be formed between the surface of the dielectric layer 17 and the X electrode 14.

After the dielectric layer 17 and the light absorbing layer 10 are formed, on the surface of this dielectric layer 17, a protective layer 18 is stacked and formed. The protective layer 18 can be formed by a thin-film formation step well-known in the field such as an electron beam evaporation method and a sputtering method.

(b) Next, the rear substrate structure 12 shown in FIG. 1 is formed. The rear substrate structure 12 is formed as follows, for example.

First, the rear substrate 19 is prepared and one surface (second surface) thereof is formed with the address electrode 20 by a predetermined pattern. When the address electrode 20 uses Ag and Au similarly to the X bus electrode 14b and the Y bus electrode 15b, a thick-film formation technique such as the screen printing is used, and a thin-film formation technique such as an evaporation method and a sputtering method as well as an etching method are used with respect to other metals (Al, Cu, Cr and the layered body thereof), so that the address electrode 20 can be formed in the predetermined number of pieces, thickness, width, and intervals.

Next, on the surface of the rear substrate 19, the dielectric layer 21 is formed so as to cover the address electrode 20. This dielectric layer 21 can be formed by using the same material and the same method as the dielectric layer 17.

Next, on the surface of the dielectric layer 21, a barrier rib 22 for partitioning the discharge space 24 is formed. The barrier rib 22 is formed so as to extend along the address electrode 20. This barrier rib 22 can be formed by a sand blast method, a photoetching method, and the like.

For example, in the sand blast method, a frit paste made of a low-melting glass frit, a binder resin, a solvent, and the like is coated and dried on the dielectric layer 21, and after that, in a state in which a cutting mask having an opening of a barrier rib pattern is provided on the frit past layer, cutting grains are sprayed, so that the frit paste layer exposed on the opening portion of the mask is cut, and the layer is further fired, thereby forming the barrier rib.

Further, in the photoetching method, in place of cutting by cutting particles, a photosensitive resin is used for the binder resin, and after the exposure and development using the mask, the barrier rib is formed by baking.

Next, the phosphor 23 is coated inside each discharge space 24 partitioned by the barrier rib 22, and is heated to be formed. The phosphors 23r, 23g, and 23b are coated with a phosphor paste containing a phosphor powder, a binder resin, and a solvent inside the discharge space partitioned by the barrier rib by a method using the screen printing or dispenser or the like and this coating is repeated for each color, and after that, the phosphors are formed by baking.

The phosphor 23 can be formed by a photolithography technique by using a sheet-like phosphor layer material (so-called green sheet) containing a phosphor power, a photosensitive material, and a binder resin. In this case, a sheet having a predetermined color is pasted on the whole surface of the display region on the substrate, and exposure and development are performed, and this is repeated for each color, so that the phosphor 23 of each color can be formed between the corresponding barrier ribs 22.

Note that, the rear substrate structure 12 is not necessarily prepared at this stage, but may be prepared prior to a step (c) to be described later.

(c) Next, the first surface side of the front substrate structure 11 and the second surface side of the rear substrate structure 12 are opposed to each other and superposed to be assembled.

In this process, the electrode group (X electrode 14, Y electrode 15, and address electrode 20) formed in any one of the respective substrate structures 11 and 12 is, for example, aligned so as to have a predetermined positional relationship as shown in FIG. 5, and after that, it is fixed in an superposed state, and the outer periphery of each of the substrate structures 11 and 12 is sealed by a sealing agent not illustrated (for example, a seal frit) and the like.

After the outer periphery of each of the substrate structures 11 and 12 is sealed, a gas of the inner space of the discharge space 24 is exhausted through a vent hole (not illustrated) formed at least at either one of the substrate structures 11 and 12. After that, a predetermined discharge gas mixed with Xe, Ne, and the like is sealed through the vent hole at a predetermined pressure. After the discharge gas is sealed, the air vent is sealed, so that the PDP 1 shown in FIG. 4 is obtained.

### Second Embodiment

In the first embodiment, as the adjusting means of the visible light transmissivity of the first region 30, the embodiment selectively forming the light absorbing layers 10, 36, and 41 between the surface of the dielectric layer 17 and the X electrode 14 has been described. In a second embodiment, an embodiment using another method as the adjusting means of the visible light transmissivity will be described.

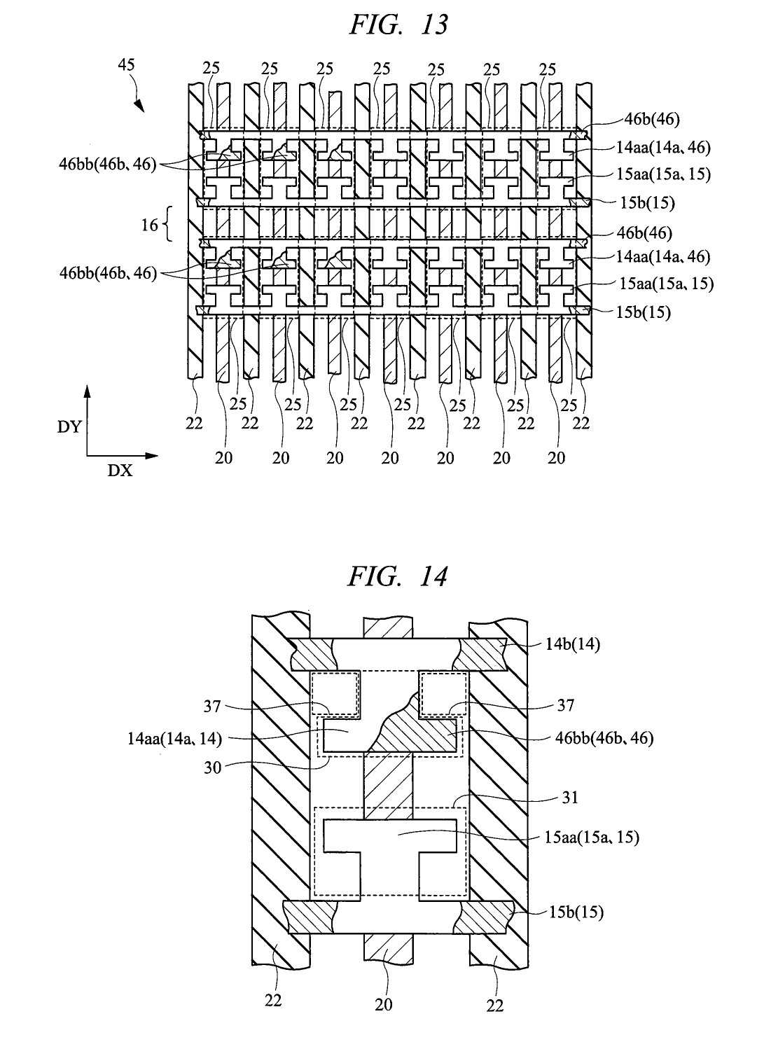

FIG. 13 is an enlarged plan view of main parts seen from the display surface side showing a two-dimensional positional relationship among an electrode group, a barrier rib, and a light absorbing layer comprised in a PDP which is the second embodiment. FIG. 14 is an enlarged plan view of main parts showing one piece of a cell 25 of the PDP shown in FIG. 13.

An X bus electrode 46b shown in FIGS. 13 and 14 is the same as the X bus electrode 14b described in FIGS. 4, 5, and 8 except for the planar shape, and therefore, the repeated description thereof will be omitted.

The differences between a PDP 45 shown in FIG. 13 and the PDP 1 shown in FIG. 5 are the planar shape of the X bus electrode 46b firstly, and that the PDP 45 does not have the light absorbing layer 10 shown in FIG. 5 secondly. That is, in the PDP 45 shown in FIG. 13, the light absorbing layer 10 is not formed as the adjusting means of the visible light transmissivity, but the planar shape of the X bus electrode 46b is made as a shape having a protruded portion 46bb protruding in the direction of a pair of Y electrodes 15 for every cell 25.

That is, in the PDP 45 of the second embodiment, the X bus electrode 46b configuring an X electrode 46 is formed along the X transparent electrode 14a.

The X bus electrode 46b is made of the same metal material as the X bus electrode 14b shown in FIG. 5 described in the first embodiment. Consequently, as shown in FIG. 14, the first region 30 superposed with the protruded portion 46bb of the X bus electrode 46b in the thickness direction is made to be lower in visible light transmissivity than the second region 31 superposed with a protruded portion 15aa of a Y transparent electrode 15a in the thickness direction.

Consequently, the visible light emitted at the time of reset discharge is absorbed, and the contrast can be improved.

However, when the X bus electrode 46b is used as the adjusting means of the visible light transmissivity, the visible light transmissivity of the X bus electrode 46b is difficult to adjust the transmissivity as compared with the light absorbing layers 10, 36, and 41 described in the first embodiment.

Therefore, when comparing the PDP 1 (see FIG. 5), the PDP 35 (see FIG. 9), and the PDP 40 (see FIG. 11) described in the first embodiment, the visible light at the time of the sustain discharge may be absorbed by a large amount. Consequently, in terms of suppressing the brightness lowering, the structures shown in the PDP 1 (see FIG. 5), the PDP 35 (see FIG. 9), and the PDP 40 (see FIG. 11) are more preferable.

In FIG. 13, a description has been made on a structure in which the X transparent electrode 14a is formed and the X bus electrode 46b is formed along this transparent electrode 14a. However, as a modification example thereof, the structure may be such that the X electrode 46 is formed only by the X bus electrode 46b (that is, the structure where the X transparent electrode 14a shown in FIG. 13 is not formed).

### Third Embodiment

In the first embodiment, as the adjusting means of the visible light transmissivity of the first region 30, descriptions has been made on the embodiment in which the light absorbing layers 10, 36, and 41 are selectively formed between the surface of the dielectric layer 17 and the X electrode 14. In the third embodiment, an embodiment will be described, in which the adjusting means of the visible light transmissivity is provided outside of the PDP.

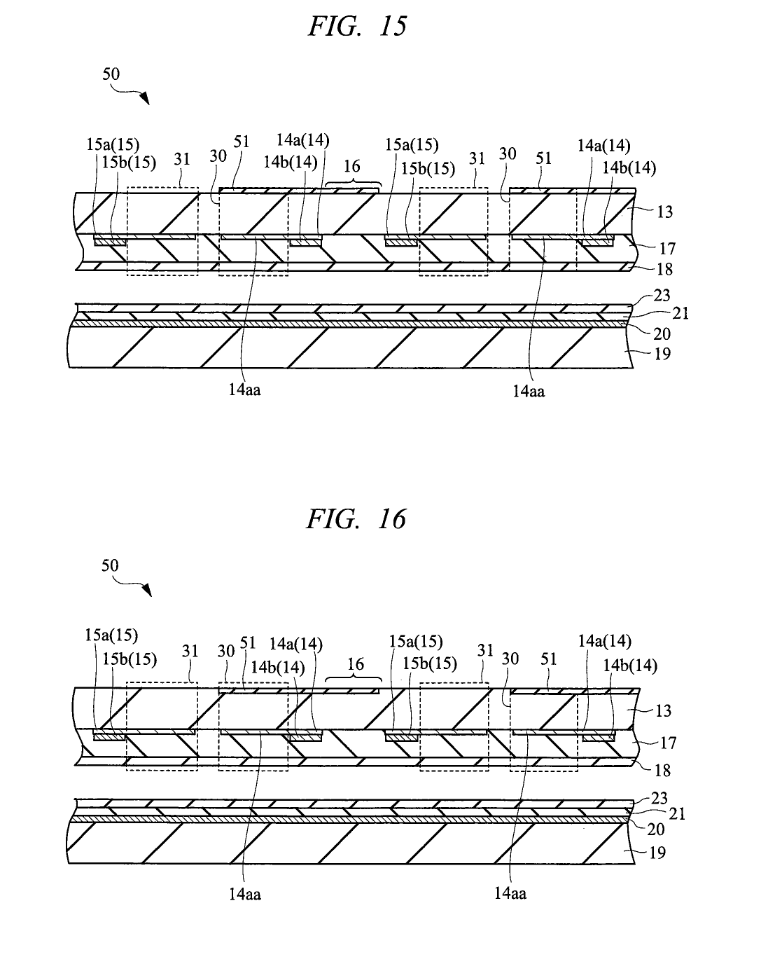

FIG. 15 is an enlarged cross-sectional view of main parts showing a part of section in the row direction of the PDP which is a modification example of the third embodiment, and FIG. 16 is an enlarged cross-sectional view of main parts showing a part of the cross section in the row direction of the PDP which is a modification example of the third embodiment.

A difference between a PDP 50 of the third embodiment and the PDP 1 (see FIG. 5), the PDP 35 (see FIG. 9), and the PDP 40 (see FIG. 11) described in the first embodiment is that a light absorbing layer 51 is not formed inside the PDP 50, but formed at a display surface side (that is, at the outside).

In the case of the PDP 1 (see FIG. 5), the PDP 35 (see FIG. 9), and the PDP 40 (see FIG. 11) as described in the first embodiment, it is difficult to use an organic material as its material to form the light absorbing layers 10, 36, and 41 inside the dielectric layer 17. This is because, when an organic material is used, an organic component is evaporated in case it is heated in the manufacturing process so that an impurity concentration inside the discharge space 24 would increase.

However, in the third embodiment, as shown in FIG. 15, since the light absorbing layer 51 is formed at the display surface side of the front substrate structure 11, that is, at the outside of the PDP 50, no such restriction is imposed. Consequently, a pigment including an organic material as the light absorbing layer 51, for example, squarylium dye, azomethine dye, cyanine dye, oxonol dye, anthraquinone dye, azo dye, benzylidene dye or a pigment made by insolubilizing these dyes can be selected according to a desired visible light transmissivity property.

In other words, by forming the light absorbing layer 51 on the display surface side of the front substrate structure 11, alternatives for adjusting the visible light transmissivity of the first region 30 are increased, and therefore, the visible light transmissivity can be more easily adjusted in addition to the effects described in the first embodiment.

The planar shape and the two-dimensional arrangement of the light absorbing layer 51 can be applied to the planar shape and the two-dimensional arrangement of the light absorbing layers 10, 36, and 41 described in FIG. 5, FIG. 9 or FIG. 11 in the first embodiment, and therefore, the illustration and repetitive descriptions thereof will be omitted.

In the manufacturing process of the PDP 50 according to the third embodiment, the step of forming the light absorbing layer 10 in the manufacturing method of the PDP 1 described in the first embodiment can be omitted. Further, in the step (c), after the front substrate structure 11 and the rear substrate structure 12 are assembled, the display surface side (display surface side of the front substrate 13) of the front substrate structure 11 is coated with a paste of the light absorbing layer 51, for example, by the screen printing method, and after that, this is heated if necessary, thereby obtaining the PDP 50.

The arrangement in the thickness direction of the light absorbing layer 51 as shown in FIG. 16 may be formed so as to bury the light absorbing layer 51 in the display surface side of the front substrate structured 11. By burying the light absorbing layer 51, the surface of the front substrate structure 11 can be flattened.

By flattening the surface of the front substrate structure 11, when a color tone adjusting filter is directly adhered to the display surface side of the PDP 50, the filter can be easily adhered with no space therebetween.

As shown in FIG. 16, when the light absorbing layer 51 is buried at the display surface side of the front substrate structure 11, the display surface side of the substrate 13 is cut to a predetermined pattern in advance by a sand blast method, and after that, it is coated by screen printing or a dispenser, and then, it is heated if necessary, thereby obtaining the light-absorbing layer 51.

In this case, in the manufacturing process described in the first embodiment, the sand blast is preferably formed in advance before the protective layer 18 is formed in the front substrate structure 11. This is because contamination of the protective layer 18 at the time of performing the sand blast is prevented.

In addition to the structures shown in FIGS. 15 and 16, the visible light transmissivity of a filter (color tone adjusting filter) directly adhered to the display surface of the PDP is adjusted in advance, and the visible light transmissivity of the first region 30 can be made lower than that of the second region 31.

However, in this case, at the time of adhering the filter, an alignment with the front substrate structure 11 and the filter is necessary to be performed.

In the foregoing, the invention made by the inventors of the present invention has been concretely described based on the embodiments. However, it is needless to say that the present invention is not limited to the foregoing embodiments and various modifications and alterations can be made within the scope of the present invention.

For example, the PDP has a variety of structures according to the required performance and the drive system, and it can be also applied to a PDP having a structure different from the PDPs 1, 35, 40, 45, and 50 described in the first to the third embodiments.

For example, in the first to the third embodiments, as an example of the electrode structure of the PDP, descriptions has been made on a structure example in which the address electrode 20 is formed in the rear substrate structure 12. However, a structure in which the address electrode 20 is formed in the front substrate structure 12 (for example, the structure formed inside a second dielectric layer by stacking the second dielectric layer between the dielectric layer 17 and the protective layer 18) is also known, and the PDP may be applied to such a structure. When the two-dimensional positional relationship between the X electrode 14 and the Y electrode 15 is the same, the PDP can be applied as it is.

Further, in the first to the third embodiments, a structure formed with the non-discharge gap 16 between the display electrode pairs of the X electrode 14 and the Y electrode 15 has been described. However, it can be also applied to a structure so-called ALIS (Alternate Lighting of Surface Method) in which all the gaps between the adjacent X electrode 14 and the Y electrode 15 become the discharge gaps.

Further, for example, in the first embodiment, as a structure example of the PDP, a description has been made on a structure referred to as a stripe rib in which the discharge space 24 is partitioned by the barrier ribs (first barrier rib, a vertical rib) 22 extending in the line shape (vertical direction).

However, for the purpose of improving the brightness, there is a structure called as a box rib in which a plurality of horizontal barrier ribs (second barrier rib, horizontal rib) crossing this barrier rib 22 in a nearly orthogonal direction is formed, and a partition is made by the barrier rib 22 and the horizontal rib for every cell 25.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A plasma display device comprising:
a plasma display panel;
a first electrode driving circuit for driving a plurality of first electrodes formed to the plasma display panel; and
a second electrode driving circuit for driving a plurality of second electrodes formed to the plasma display panel, wherein
the plasma display panel comprises:
a first substrate structure and a second substrate structure arranged so as to oppose to each other interposing a discharge gap;
the first electrode and the second electrode formed along a first direction so that a display electrode pair is formed in the first substrate structure that is arranged at a display surface side of the plasma display panel;
a dielectric layer covering the plurality of first electrodes and the plurality of second electrodes;
a plurality of third electrodes formed in the first substrate structure or the second substrate structure along a second direction crossing the first direction; and
a plurality of cells formed at every intersection of the display electrode pairs and the plurality of third electrodes, wherein
the first electrode becomes a cathode, and the second electrode becomes an anode upon a reset discharge for forming charges to all of the plurality of cells,
the first electrode and the second electrode alternately become a cathode or an anode so as to repeatedly perform discharges upon a sustain discharge for forming a display image, wherein
the first electrode and the second electrode comprise a transparent electrode portion and a metal electrode portion electrically connected to the transparent electrode portion, respectively, and wherein
a distribution of visible light transmissivity inside the cell of the first substrate structure comprises a first region having a first visible light transmissivity and a second region having a second visible light transmissivity higher than the first visible light transmissivity, and
the first region includes a region superposed with the transparent electrode portion comprised in the plurality of first electrodes respectively in the thickness direction, and the second region includes a region superposed with the transparent electrode portion comprised in each of the plurality of second electrodes in the thickness direction.

2. The plasma display device according to claim 1, wherein
the transparent electrode portions of the first electrode and the second electrode comprise a plurality of projected portions protruding toward a direction of the first electrode or the second electrode to be paired in each of the cell, and wherein
the first region includes a region superposed with an edge of the protruded portion of the first electrode in a thickness direction, and
the second region includes a region superposed with an edge of the protruded portion of the second electrode in a thickness direction.

3. The plasma display device according to claim 2, wherein
the first substrate structure is adjacently disposed in the first region between the edge of the protruded portion of the first electrode and the metal electrode portion of the first electrode, and comprises a third region having a higher visible light transmissivity than the first region.

4. The plasma display device according to claim 2, wherein
the metal electrode portion of the first electrode comprises a protruded portion along the transparent electrode portion of the first electrode, thereby making the visible light transmissivity of the first region lower than that of the second region.

5. The plasma display device according to claim 1, wherein
the second electrode is a scan electrode for applying a scan pulse upon an address discharge for selecting on/off of the cell.

6. The plasma display device according to claim 1, wherein
the first region of the first substrate structure is formed with a light absorbing layer, thereby lowering the visible light transmissivity of the first region.

7. The plasma display device according to claim 6, wherein
the light absorbing layer is formed between a surface of the dielectric layer and the first electrode.

8. The plasma display device according to claim 7, wherein
a light absorbing material forming the light absorbing layer comprises one kind or two or more kinds of inorganic pigments selected from a group comprising titanium oxide, black iron oxide, chrome oxide, manganese oxide, carbon black, and ultramarine blue pigment.

9. The plasma display device according to claim 6, wherein
the light absorbing layer is formed at the display surface side of the first substrate structure.

10. The plasma display device according to claim 9, wherein
the light absorbing material forming the light absorbing layer comprises a pigment containing an organic material.

11. A plasma display device comprising:
a plasma display panel;
a first electrode driving circuit for driving a plurality of first electrodes formed to the plasma display panel; and
a second electrode driving circuit for driving a plurality of second electrodes formed to the plasma display panel, wherein
the plasma display panel comprises:
a first substrate structure and a second substrate structure arranged so as to oppose to each other interposing a discharge gap;
the first electrode and the second electrode formed along a first direction so that a display electrode pair is formed in the first substrate structure that is arranged at a display surface side of the plasma display panel;
a dielectric layer covering the plurality of first electrodes and the plurality of second electrodes;
a plurality of third electrodes formed in the first substrate structure or the second substrate structure along a second direction crossing the first direction; and
a plurality of cells formed at every intersection of the display electrode pairs and the plurality of third electrodes, wherein
the first electrode becomes a cathode, and the second electrode becomes an anode upon a reset discharge for forming charges to all of the plurality of cells,
the first electrode and the second electrode alternately become a cathode or an anode so as to repeatedly perform discharges upon a sustain discharge for forming a display image, wherein
the first electrode comprises a metal electrode portion having a protruded portion extending in the direction of the second electrode to be paired,
the second electrode comprises a transparent electrode portion having a protruded portion extending in the direction of the first electrode to be paired, and a metal electrode portion electrically connected to the transparent electrode portion, and wherein
a distribution of visible light transmissivity inside the cell of the first substrate structure has a first region having a first visible light transmissivity and a second region having a second visible light transmissivity higher than the first visible light transmissivity, and
the first region includes a region superposed with an edge of the metal electrode portion comprised in each of the plurality of first electrodes in a thickness direction, and the second region includes a region superposed with an edge of the protruded portion of the transparent electrode portion comprised in each of the plurality of second electrodes in a thickness direction.

12. An AC type plasma display panel comprising:
a first substrate structure and a second substrate structure arranged so as to oppose to each other interposing a discharge gap;
the first electrode and the second electrode formed along a first direction so that a display electrode pair is formed in the first substrate structure that is arranged at a display surface side of the plasma display panel;
a dielectric layer covering the plurality of first electrodes and the plurality of second electrodes;
a plurality of third electrodes formed in the first substrate structure or the second substrate structure along a second direction crossing the first direction; and
a plurality of cells formed at every intersection of the display electrode pairs and the plurality of third electrodes, wherein
the first electrode becomes a cathode, and the second electrode becomes an anode upon a reset discharge for forming charges to all of the plurality of cells,
the first electrode and the second electrode alternately become a cathode or an anode so as to repeatedly perform discharges upon a sustain discharge for forming a display image, wherein
the first electrode and the second electrode comprise a transparent electrode portion and a metal electrode portion electrically connected to the transparent electrode portion, respectively, and wherein
a distribution of visible light transmissivity inside the cell of the first substrate structure comprises a first region having a first visible light transmissivity and a second region having a second visible light transmissivity higher than the first visible light transmissivity, and
the first region includes a region superposed with the transparent electrode portion comprised in the plurality of first electrodes respectively in the thickness direction, and the second region includes a region superposed with the transparent electrode portion comprised in each of the plurality of second electrodes in the thickness direction.

13. The plasma display panel according to claim 12, wherein
the transparent electrode portions of the first electrode and the second electrode comprise a plurality of projected portions protruding toward a direction of the first electrode or the second electrode to be paired in each of the cell, and wherein
the first region includes a region superposed with an edge of the protruded portion of the first electrode in a thickness direction, and
the second region includes a region superposed with an edge of the protruded portion of the second electrode in a thickness direction.

14. The plasma display panel according to claim 13, wherein
the first substrate structure is adjacently disposed in the first region between the edge of the protruded portion of the first electrode and the metal electrode portion of the first electrode, and comprises a third region having a higher visible light transmissivity than the first region.

15. The plasma display panel according to claim 13, wherein
the metal electrode portion of the first electrode comprises a protruded portion along the transparent electrode portion of the first electrode, thereby making the visible light transmissivity of the first region lower than that of the second region.

16. The plasma display panel according to claim 12, wherein
the second electrode is a scan electrode for applying a scan pulse upon an address discharge for selecting on/off of the cell.

17. The plasma display panel according to claim 12, wherein
the first region of the first substrate structure is formed with a light absorbing layer, thereby lowering the visible light transmissivity of the first region.

18. The plasma display panel according to claim 17, wherein
the light absorbing layer is formed between a surface of the dielectric layer and the first electrode.

19. The plasma display panel according to claim 18, wherein
a light absorbing material forming the light absorbing layer comprises one kind or two or more kinds of inorganic pigments selected from a group comprising titanium oxide, black iron oxide, chrome oxide, manganese oxide, carbon black, and ultramarine blue pigment.

20. The plasma display panel according to claim 17, wherein
the light absorbing layer is formed at the display surface side of the first substrate structure.

21. The plasma display panel according to claim 20, wherein
the light absorbing material forming the light absorbing layer comprises a pigment containing an organic material.

22. An AC type plasma display panel according to claim 12, wherein the first visible light transmissivity is greater than or equal to 50% and less than or equal to 90%.

23. An AC type plasma display panel comprising:
a front substrate;
a rear substrate arranged so as to oppose to the front substrate;
a first electrode and a second electrode formed so as to extend in a first direction so that a display electrode pair is formed to the front substrate; and
a third electrode formed on the rear substrate so as to extend in a second direction crossing the first direction, wherein
the first electrode comprises a transparent electrode portion and a metal electrode portion and is an electrode which becomes a cathode upon a reset discharge,
the second electrode comprises a transparent electrode portion and a metal electrode portion and is an electrode which becomes an anode upon a reset discharge, and
a visible light transmissivity of a first region superposed with the transparent electrode portion of the first electrode is lower than that of a second region superposed with the transparent electrode portion of the second electrode.
